(19) United States
(12) Patent Application Publication
(10) Pub. No.: US 2024/0181505 A1
(43) Pub. Date: Jun. 6, 2024

(54) TELLTALE CLEARING TOOL

(71) Applicants: Albert Simpson, Selbyville, DE (US); Michael Tyler, Selbyville, DE (US)

(72) Inventors: Albert Simpson, Selbyville, DE (US); Michael Tyler, Selbyville, DE (US)

(21) Appl. No.: 18/072,925

(22) Filed: Dec. 1, 2022

(51) Int. Cl. B08B 9/043; B08B 13/00; B63H 20/00

(52) U.S. Cl. CPC B08B 9/0436; B08B 13/00; B63H 20/00; B08B 2209/04; B63H 2020/008

(57) ABSTRACT

The “telltale” of an outboard motor is a feature that signals to the operator that the cooling system is working properly. The narrow passage of the telltale can easily become clogged. The telltale clearing tool of the present invention comprises an attachment mechanism, a float, and a path-clearing mechanism. The attachment mechanism allows the tool to be secured to a variety of locations on a boat for easy access when the tool is needed. The float ensures the tool will not sink if dropped in the water. The path-clearing mechanism is flexible enough to traverse the narrow passage of the telltale, but not so rigid as to puncture or tear the tubing, and further is of sufficient length to clear most clogs, but not long enough to enter and/or damage the fuel cooler.

### FIELD OF THE INVENTION

This invention relates to a tool for clearing the telltale of the outboard motor of a boat.

### BACKGROUND OF THE INVENTION

Many boats are propelled by outboard motors comprising an internal combustion engine connected to a propeller. To prevent overheating, a pump draws water from beneath the motor, circulates it around the engine to draw off heat, and expels the water back out of the motor. If this cooling system fails, the outboard motor could overheat and leave the boat operator stranded. Therefore, monitoring and maintaining this cooling system is vital.

One feature of many outboard motors that enables the operator to monitor the function of the cooling system is a “telltale.” When the cooling system is operating properly, a stream of water is ejected from the motor under the pressure of the water pump. The exit of this telltale is above the waterline, thereby giving the boat operator a simple visual cue that the cooling system is functioning properly. If the stream from the telltale stops or is weaker than usual, it may be a sign that the cooling system is beginning to fail.

However, the input to the telltale is narrow and its path comprises flexible tubing with a thin internal diameter. Dirt, debris, plant life, spiders, insects, their webs or nests, and other material can easily clog the telltale, diminishing its stream. In such case, the cooling system itself may be functioning well, but the operator may believe the cooling system is malfunctioning. Thus, when the stream of the telltale weakens or stops, the first step to determining the problem is to try to verify that the path of the telltale is clear.

Fully examining the telltale requires disassembly of some portions of the outboard motor. When out on the water, this would be difficult if not impossible. The best option is to attempt to pass an object through the exit of the telltale and down the flexible tube path toward the input. Until now there has been no tool specifically designed for this purpose, so boat operators have had to improvise with whatever they can find on their boat at the time. This presents numerous challenges. The operator must search through the boat to find a suitable object, which may be difficult if the boat is crowded, or weather or water conditions are rough. The object must be long enough to traverse nearly the entire path of the telltale, but if it extends too far, it may damage the fuel cooler. It must be flexible enough to conform to any bends or curves in the path. It must be rigid enough to clear a clog and to not bunch up in the path, but not so rigid that it can tear or puncture the flexible tubing.

Further, because the outboard motor extends over the side of the boat and the exit to the telltale is directed away from the boat, accessing the telltale to try to clear its path requires the operator to hang over the back of the boat in an awkward position. If the object being used to clear the telltale is dropped, it may sink and be lost.

There is a need for a tool specifically designed to clear the path of a telltale. This tool should be easily accessible, long enough and flexible enough to nearly traverse the entire path of the telltale, not long enough to enter or damage the fuel cooler, rigid enough to clear a clog and not get stuck in the path, not so rigid as to tear or puncture flexible tubing, and should float if dropped in the water.

### SUMMARY OF THE INVENTION

The general object of this invention is to provide a tool that can easily be used to clear the path of an outboard motor's telltale. Further, the invention floats in water, enabling easy retrieval if it is dropped during use. Further, the invention has a mechanism allowing it to be easily secured to various objects in order to keep it accessible when not in use.

The present invention is a new telltale clearing tool that comprises: an attachment mechanism, a float, and a path-clearing mechanism.

These and other objects, advantages, and features of the invention are set forth in the detailed description, which follows.

### BRIEF DESCRIPTION OF THE DRAWINGS

FIG. 1 is a perspective view of one embodiment of the telltale clearing tool.

FIG. 2 is a perspective view of one embodiment of the telltale clearing tool in which the float portion is depicted in cross-section.

FIG. 3 is a perspective view of one embodiment of the telltale clearing tool in which the attachment mechanism is depicted as a labeled representation.

### DETAILED DESCRIPTION OF THE INVENTION

The following description includes exemplary embodiments of the invention. This description is not to be taken in a limiting sense, but is meant only to illustrate the general principles of the invention. Various inventive features are described below that can each be used independently or in combination.

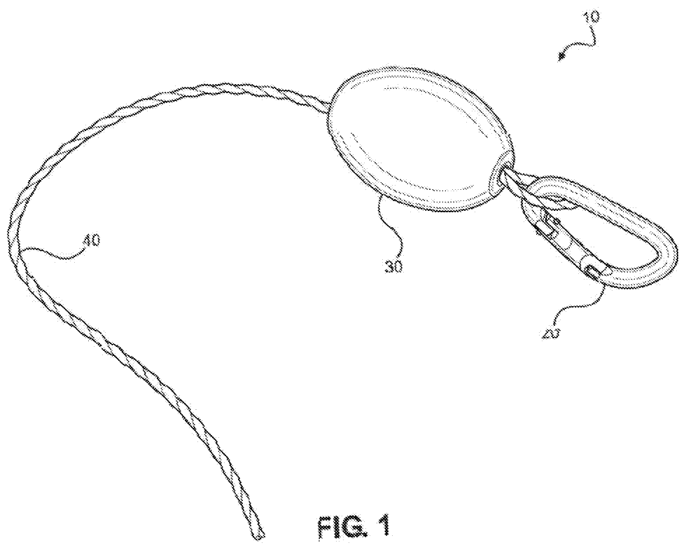

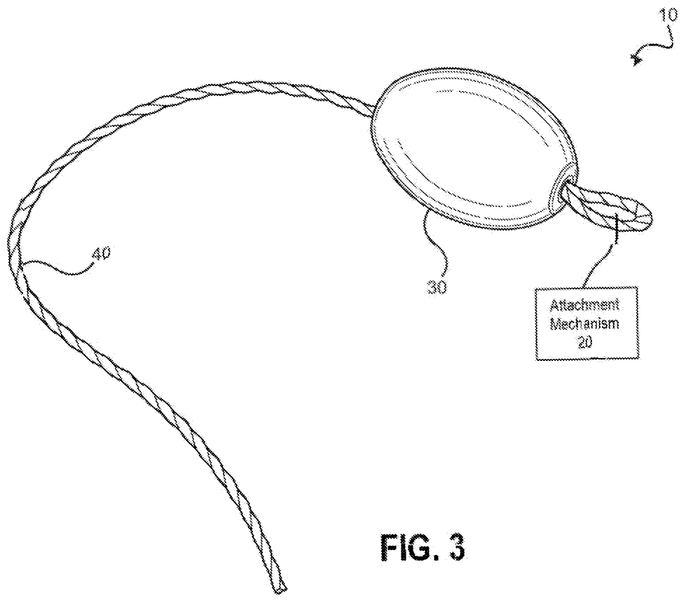

The invention may be better understood by reference to the drawings. Referring to FIG. 1, an embodiment of the telltale clearing tool 10 of this invention comprises an attachment mechanism 20, a float 30, and a path clearing mechanism 40. The attachment mechanism 20 shown in FIG. 1 is a common carabiner, but one of ordinary skill in the art would understand that many attachment mechanisms are possible. See FIG. 3. The purpose of the attachment mechanism is to enable securing the telltale clearing tool to a convenient storage location for easy access when the tool is needed. Possible attachment mechanisms include, but are not limited to: spiral rings (keyrings), spring clips, lobster claw clasps, snap hooks, trigger snaps, swivel hooks, bolt snaps, and hooks, as well as straps with snaps, buttons, magnets, or mating hook-and-loop components.

The float 30 shown in FIG. 1 is an oval, hollow plastic design with a bore through the long axis. One of ordinary skill in the art would understand that many shapes and materials are possible without detracting from the spirit of the invention. The float 30 has two purposes: 1) to ensure that the telltale clearing tool does not sink if dropped in water and, 2) to allow the user to easily grasp the tool while attempting to clear the telltale. Accordingly, the float must be of sufficient size and composition to provide enough buoyancy to keep the entire tool from sinking, but small enough to comfortably fit in the hand of a user. In one embodiment, the float is one to six inches in length, more preferably two to four inches in length. In one embodiment the float is one-half inch to three inches in diameter, more preferably one to two inches in diameter. Suitable materials include, but are not limited to: plastics; foams made of polystyrene, polyvinyl chloride, ethylene-vinyl acetate, or other plastics; wood; and other buoyant materials. Optionally, the float may be comprised of more than one material, such as foam coated in plastic, rubber, or paint. In one embodiment, the float 30 has an internal bore through its long axis. This bore may have a sleeve inserted into it comprised of plastic, metal, or other suitable material. In another embodiment, the float may be solid, with no bore. The float 30 may be configured in a variety of shapes, including, but not limited to: ovoid, spherical, egg-shaped, regular polyhedral or irregular polyhedral. In one embodiment, the float is an irregular shape designed to ergonomically fit in a user's hand, to facilitate grasping the tool while attempting to unclog a telltale. In one embodiment, the surface of the float 30 is smooth. In another embodiment, the surface of the float 30 is rough to facilitate grasping the tool by the user. In yet another embodiment, the surface of the float 30 has an irregular surface with indentations and/or protrusions to facilitate grasping the tool by the user.

The path clearing mechanism 40 may be comprised of any material that is rigid enough to pass through the length of the telltale and to push, penetrate, or grind up debris contained therein, yet flexible enough to navigate bends and turns in the path of the telltale. The path clearing mechanism should not be so rigid as to cut or puncture rubber or plastic tubing in the telltale path. Suitable materials include, but are not limited to: hardened monofilament nylon line; nylon reinforced with aluminum; nylon composite materials; braided nylon lines, and nylon polymer composites. The cross section of the path clearing mechanism 40 may be circular, oval, triangular, square, diamond, rectangular, polygonal with five to eight sides, or star-shaped with three to eight points. The path clearing mechanism 40 may be straight along its longitudinal axis or may be twisted or spiral as shown in FIG. 1. The surface of the path clearing mechanism 40 may be smooth or may have spikes, burrs, or serrations.

The path clearing mechanism 40 must be of sufficient length to traverse nearly the entire path of the telltale, but not longer than said path. At the end of the telltale's path is located a fuel cooler. If the path clearing mechanism 40 is longer than the path of the telltale, the end may become stuck in and/or damage the fuel cooler. Accordingly, it is essential that the second end 42 of the path clearing mechanism 40 not extend beyond the float 30 a distance longer than the length of the telltale's path. In one embodiment, the path clearing mechanism 40 extends beyond the float 30 between 10 and 12.25 inches. As the telltale path of most boat outboard motors is at least twelve inches, in one embodiment, the path clearing mechanism 40 extends beyond the float 30 between 12 and 12.25 inches. In an alternative embodiment, the telltale clearing tool 10 is designed for a specific brand and/or size of outboard motor and the length that the path clearing mechanism 40 extends beyond the float 30 is designed to match the length of the telltale path for said motor. In one embodiment, the path clearing mechanism 40 extends beyond the float 30 between ten and twenty inches. In another embodiment, the path clearing mechanism 40 extends beyond the float 30 between twelve and eighteen inches. In another embodiment, the path clearing mechanism 40 extends beyond the float 30 between twelve and sixteen inches. In another embodiment, the path clearing mechanism 40 extends beyond the float 30 between twelve and fourteen inches.

In embodiments in which the path clearing mechanism 40 has a cross-section that is circular, the diameter of the path clearing mechanism 40 is between 0.065 and 0.2 inches. In embodiments in which the path clearing mechanism 40 has a cross-section that is not circular, the maximum diameter is between 0.065 and 0.2 inches. In one embodiment, the maximum diameter of the path clearing mechanism 40 is between 0.065 and 0.15 inches. In another embodiment, the maximum diameter of the path clearing mechanism 40 is between 0.065 and 0.12 inches. In another embodiment, the maximum diameter of the path clearing mechanism 40 is between 0.09 and 0.10 inches.

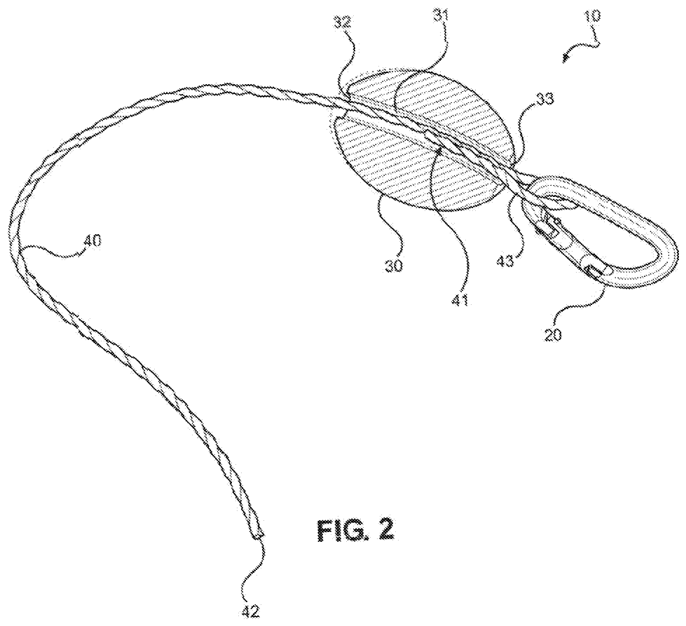

There are many ways that the three main components of the invention may be connected to one another. In the embodiment shown in FIGS. 1 through 3, the float 30 has a bore 31 through its longitudinal axis. A first end 41 of the path clearing mechanism 40 enters a first opening 32 to the bore, passes through the bore 31 and out a second opening 33 to the bore, forms a loop 43 and inserts back into the second opening 33 of the bore, and terminates inside the bore 31. The attachment mechanism 20 connects to the loop 43. In this embodiment, the float may be secured to the path clearing mechanism by friction fit, through the use of adhesives, or through the use of mechanical fasteners. In another embodiment, the first end 41 of the path clearing mechanism 40 extends all the way through the bore 31 and back out through the first opening 32 to the bore.

Many other configurations are possible. In one embodiment, a double-ended hook extends through the float 30, with one hook connected to the attachment mechanism 20 and the other hook connected to the path clearing mechanism 40. In another embodiment, a first hook or loop is inserted into one end of the float 30 and connected to the attachment mechanism 20 and a second hook or loop is inserted into the other end of the float and connected to the path clearing mechanism 40.

Modifications and variations in the construction and arrangement of the telltale clearing tool disclosed herein can be made without departing from the subject and spirit of the invention. One of ordinary skill in the art would recognize that other configurations are possible and such modifications and variations are within the scope of the invention.

I claim:

1. A tool for clearing the telltale of an outboard motor, comprising; an attachment mechanism, a float, and a path-clearing mechanism.

2. The tool of claim 1, wherein the path-clearing mechanism is made from a material selected from the group consisting of hardened monofilament nylon line; nylon reinforced with aluminum; nylon composite materials; braided nylon lines, and nylon polymer composites.

3. The tool of claim 2, wherein the path-clearing mechanism is made from hardened monofilament nylon line.

4. The tool of claim 1, wherein the path-clearing mechanism has a cross-section with a shape selected from the group consisting of circular, oval, triangular, square, diamond, rectangular, polygonal with five to eight sides, and star-shaped with three to eight points.

5. The tool of claim 1, wherein the path-clearing mechanism has a cross-section that is star-shaped with three points and is twisted along its length.

6. The tool of claim 1, wherein the float has a bore through its long axis.

7. The tool of claim 6, wherein the path-clearing mechanism further comprises a first end and a second end, wherein said first end is inserted into a first opening to the bore, passes through the bore and out a second opening to the bore, forms a loop and is inserted back into the second opening to the bore, and passes at least partially back through the bore.

8. The tool of claim 7, wherein the attachment mechanism is attached to said loop.

9. The tool of claim 7, wherein the second end of the path-clearing mechanism extends beyond the first opening to the bore of the float by twelve to twelve and one quarter inches.

10. The tool of claim 1, wherein the float is made from a material selected from the group consisting of plastic, plastic foam, and wood.

11. The tool of claim 10, wherein the plastic foam is made from a material selected from the group consisting of polystyrene, polyvinyl chloride, and ethylene-vinyl acetate.

12. The tool of claim 11, wherein the plastic foam further comprises an external coating selected from the group consisting of plastic, rubber, or paint.

13. The tool of claim 1, wherein the float has a shape that is selected from the group consisting of ovoid, spherical, egg-shaped, regular polyhedral, and irregular polyhedral.

14. The tool of claim 1, wherein the float is ovoid in shape.

15. The tool of claim 1, wherein the float has a length of between two and four inches and a diameter of between one and two inches.

16. The tool of claim 1, wherein the attachment mechanism is selected from the group consisting of carabiners, spiral rings, spring clips, lobster claw clasps, snap hooks, trigger snaps, swivel hooks, bolt snaps, hooks, straps with snaps, straps with buttons, straps with magnets, and straps with mating hook-and-loop components.

17. The tool of claim 1, wherein the attachment mechanism is a carabiner.
